(19) United States
(12) Patent Application Publication
(10) Pub. No.: US 2013/0204582 A1
(43) Pub. Date: Aug. 8, 2013

(54) Systems and Methods for Feature Detection in Mass Spectrometry Using Singular Spectrum Analysis

(71) Applicants: Ignat V. Shilov, Palo Alto, CA (US); Gordana Ivosev, Etobicoke, CA (US); Alpesh A. Patel, San Francisco, CA (US)

(72) Inventors: Ignat V. Shilov, Palo Alto, CA (US); Gordana Ivosev, Etobicoke, CA (US); Alpesh A. Patel, San Francisco, CA (US)

(73) Assignee: DH Technologies Development PTE. LTD, Singapore (SG)

(21) Appl. No.: 13/697,787

(22) PCT Filed: May 17, 2011
(86) PCT No.: PCT/US2011/036723

§ 371 Date: Dec. 28, 2012

Related U.S. Application Data
(60) Provisional application No. 61/345,410, filed on May 17, 2010.

(51) Int. Cl. H01J 49/00

(52) U.S. Cl. CPC H01J 49/0036
USPC 702/194

(57) ABSTRACT

Singular spectrum analysis is used to detect a feature from mass spectrometry data. A plurality of scans of a sample is performed producing mass spectrometry data using a spectrometer. A singular spectrum analysis is performed on the mass spectrometry data using a fixed window width in which one or more components other than the highest ranked component are grouped in a set and the one or more components grouped in the set are summed producing reconstructed data using the processor. A feature of the mass spectrometry data is detected by analyzing an aspect of the reconstructed data using the processor. Analyzing an aspect of the reconstructed data includes using pairs of zero crossings in the reconstructed data to detect bounds on a location of the feature in the mass spectrometry data.

### CROSS-REFERENCE TO RELATED APPLICATION

This application claims the benefit of U.S. Provisional Patent Application No. 61/345,410 filed May 17, 2010, which is incorporated by reference herein in its entirety.

### INTRODUCTION

Spectral or chromatographic feature detection is a critical part of mass assignment and quantitation in mass spectrometry. A feature is, for example, a peak. The presence of noise can make feature detection difficult, however. For example, the mass assignments for spectral features convolved with periodic background noise can include significant errors if the spectral features and the periodic background noise are comparable in intensity. As a result, an important aspect of feature detection is distinguishing spectral and chromatographic features from noise generated from various sources.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is an exemplary plot of mass spectrometry data and data reconstructed from the highest ranked linear component of the mass spectrometry data produced by singular spectrum analysis (SSA), in accordance with various embodiments.

FIG. 3 is an exemplary plot of mass spectrometry data and data reconstructed from the second highest ranked linear component of the mass spectrometry data produced by SSA, in accordance with various embodiments.

FIG. 4 is an exemplary plot of mass spectrometry data and reconstructed data that is reconstructed from a grouped set that includes the second and third highest ranked linear components of the mass spectrometry data produced by SSA, in accordance with various embodiments.

FIG. 5 is an exemplary plot of mass spectrometry data and reconstructed data that is reconstructed from a grouped set that includes the second, third, fourth, and fifth highest ranked linear components of the mass spectrometry data produced by SSA, in accordance with various embodiments.

FIG. 6 is a schematic diagram showing a system for detecting a feature from mass spectrometry data, in accordance with various embodiments.

FIG. 7 is an exemplary flowchart showing a method for detecting a feature from mass spectrometry data, in accordance with various embodiments.

FIG. 8 is a schematic diagram of a system of distinct software modules that performs a method for detecting a feature from mass spectrometry data, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Computer-Implemented System

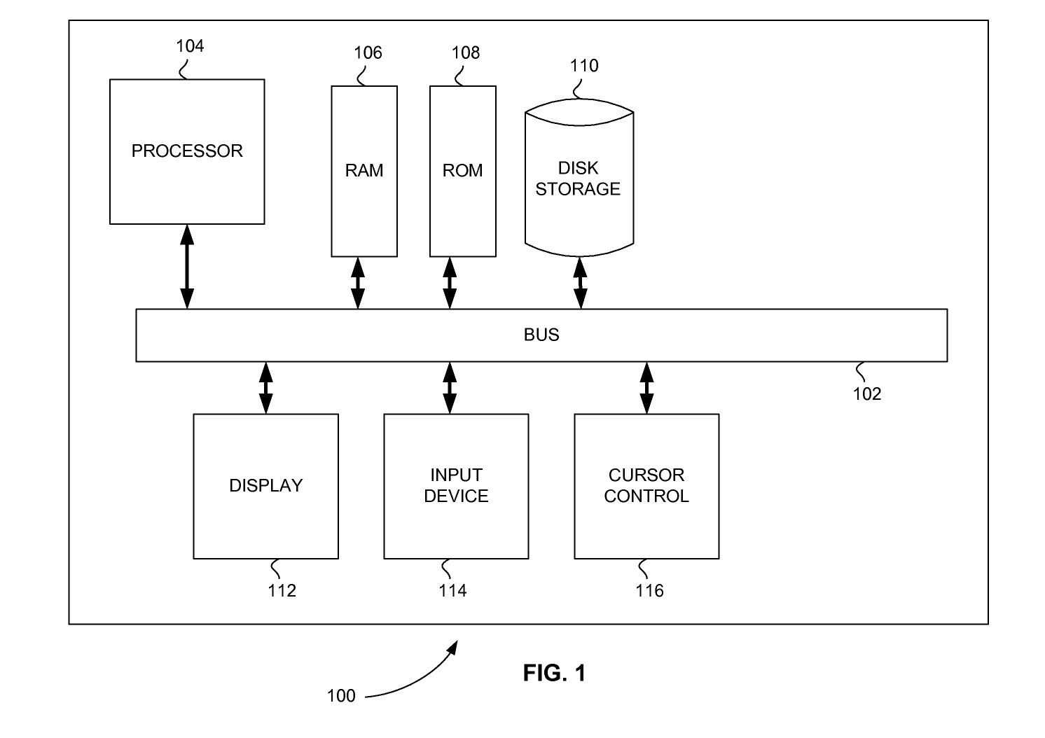

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random access memory (RAM) or other dynamic storage device, coupled to bus 102 for determining base calls, and instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively hard-wired circuitry may be used in place of or in combination with software instructions to implement the present teachings. Thus implementations of the present teachings are not limited to any specific combination of hardware circuitry and software.

The term “computer-readable medium” as used herein refers to any media that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as memory 106. Transmission media includes coaxial cables, copper wire, and fiber optics, including the wires that comprise bus 102.

Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Systems and Method for Identifying Features

As described above, an important aspect of feature detection is distinguishing features from noise. Traditionally this is done by denoising the mass spectrometry data, or removing the noise from the mass spectrometry data. For example, this can be done by modeling the noise and then subtracting the noise from the data to produce the denoised mass spectrometry data.

In general, a feature is an attribute of a point, a set, or a signal, for example. In mass spectrometry data, a feature is a group of points with a certain property or pattern. A feature can be, but is not limited to, a peak, a position of a peak centroid, a peak intensity, a peak area, or any other aspect of peak. A feature can be related to a physical property of a compound, for example. A physical property of a compound can include, but is not limited to, a mass, a charge, or a number of ions. The mass spectrometry data can include one-dimensional or multi-dimensional data. For example, the mass spectrometry data can include, but is not limited to, liquid chromatography mass spectrometry (LCMS) data, image data, a mass spectrum, or a chromatogram.

In various embodiments, features are distinguished from noise using singular spectrum analysis (SSA) to locate bounds on a location of a feature rather than to directly denoise the original mass spectrometry data. In particular, a spectrum or chromatogram is obtained. SSA is used to decompose it into linear components. A subset of the linear components that does not include the first component is identified. The components of the subset are summed. Finally, simple features in the summed component that include, but are not limited to, sign changes or local minima/maxima are used to identify bounds on a location of a feature in the mass spectrum or chromatogram.

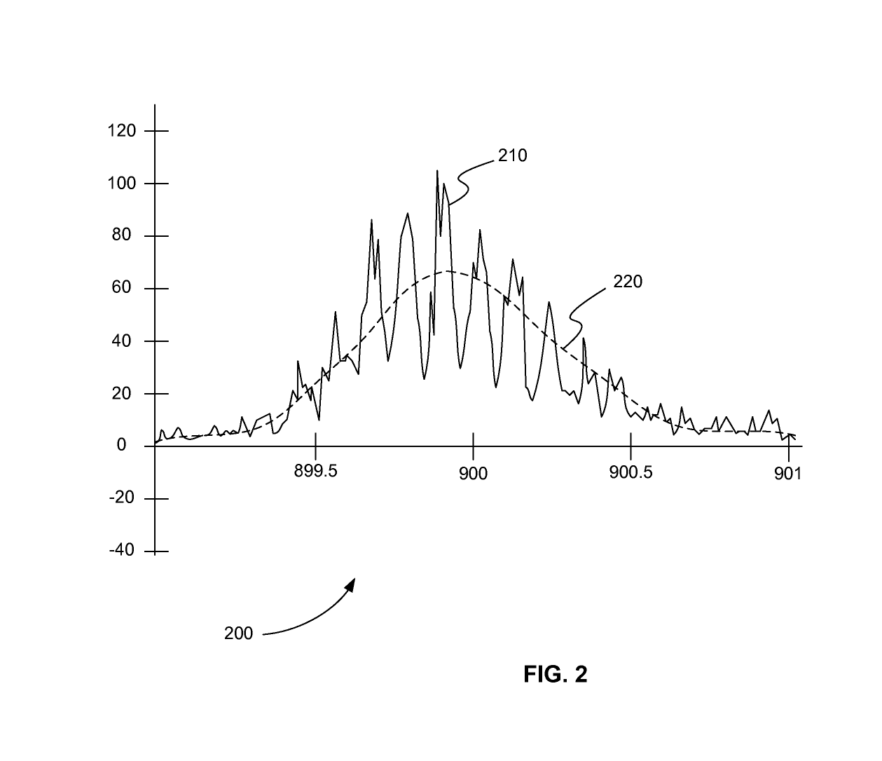

FIG. 2 is an exemplary plot 200 of mass spectrometry data 210 and data 220 reconstructed from the highest ranked linear component of mass spectrometry data 210 produced by SSA, in accordance with various embodiments. Mass spectrometry data 210 is, for example, a portion of a spectrum or a chromatogram produced by a mass spectrometer. SSA is performed on mass spectrometry data 210.

As one skilled in the art will understand, performing SSA can include the steps of embedding, singular value decomposition, grouping, and reconstruction. In the embedding step, mass spectrometry data 210 is transformed into a rectangular matrix using a sliding window with a fixed window width. In the singular value decomposition step, singular value decomposition is performed on the rectangular matrix producing linear components of mass spectrometry data 210. Each linear component includes a singular value, a left-singular vector, and a right-singular vector. The left-singular vector is as long as the embedding is tall and the right-singular vector is as long as the fixed window width. The singular value can be thought of as indicating the overall amount of signal explained by the shape described by the right-singular vector. The right-singular vector can be thought of as a particular shape that occurs in the fixed window width, and the corresponding left-singular vector can be thought of as an indication of the relative amount of that shape at a particular location within the overall mass spectrometry data 210. These linear components are ranked. They are ranked in descending order of singular value, which essentially ranks the components according to the amount of mass spectrometry data 210 they explain. The ranked components can also be referred to as harmonics or oscillations of mass spectrometry data 210.

Traditionally, the grouping step of SSA has been used to group the highest ranked components into a set that excludes the lowest ranked components. The lowest ranked components are assumed to represent noise. Data is then reconstructed in the reconstruction step using the set of highest ranked components. This reconstructed data is then considered to represent mass spectrometry data 210 without the noise. In other words, traditionally the grouping and reconstruction steps of SSA are used to remove the noise from mass spectrometry data 210.

In various embodiments, the grouping and reconstruction steps of SSA are used to identify bounds on a location of a feature in mass spectrometry data 210 rather than to remove the noise from mass spectrometry data 210. Data 220 is reconstructed from the highest ranked linear component. Therefore, data 220 explains the largest amount of mass spectrometry data 210. Data 220 smoothes out mass spectrometry data 210. For example, data 220 cuts through the features of mass spectrometry data 210 near the feature midpoints. Consequently, there can be some set of remaining components such that when that set is used to reconstruct mass spectrometry data 210, the reconstruction includes positive values for the top half of a feature and negative values for the bottom half of the feature.

In various embodiments, the grouping step of SSA groups one or more lower ranked components into a set that excludes the first or highest ranked component. The one or more lower ranked components can include consecutively ranked components or non-consecutively ranked components.

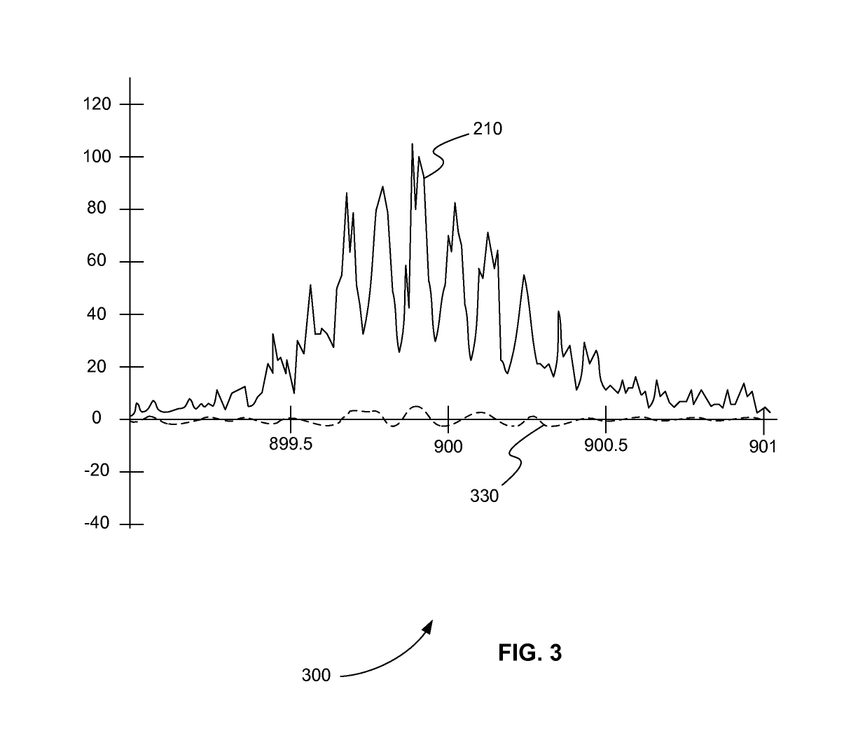

FIG. 3 is an exemplary plot 300 of mass spectrometry data 210 and data 330 reconstructed from the second highest ranked linear component of mass spectrometry data 210 produced by SSA, in accordance with various embodiments. Data 330 is reconstructed from the second highest ranked component and includes positive and negative values. The set of components that excludes the first or highest ranked component can begin with the second highest ranked component or any other component ranked lower than the highest ranked component. In various embodiments, the component selected to begin the set can be based on a heuristic. In various embodiments, the number of components selected for the set can also be based on a heuristic. For example, the one or more lower ranked components selected for the set are selected based on some correlation with each other. This correlation may include similar shapes based on a threshold value, for example.

In various embodiments, correlation among the one or more lower ranked components selected for a grouped set is found by comparing one or more aspects of each of the components. Aspects of a component compared to measure correlation can be the data reconstructed from the component, the left-singular vector and the right-singular vector. One possible cause of correlation between components may be that, with an appropriately chosen window width for the SSA embedding, there can be multiple components with right-singular vectors that represent something close to a single shape, but positioned differently within the fixed window width. The corresponding left-singular vectors then likely correlate as well with a shift that is similar in magnitude but opposite in direction from the shift between the right-singular vectors.

Adding more than one component to a set can provide more physical details about the features of mass spectrometry data 210. Adding more than one component to a set can also help distinguish features of mass spectrometry data 210 that are close together.

In various embodiments, the number of components selected for a set is based on, or a function of, the fixed window width used in the embedding step. In various embodiments, the number of components selected for a set is calculated from a sub-linear function of the fixed window width. A sub-linear function of the fixed window width is the square root of the fixed window width, for example.

The fixed window width is based on the number of data points received from the mass spectrometer. The number of data points provided by the mass spectrometer is based on the instrument resolution and point spacing, for example. In various embodiments, the fixed window width is at least as wide as the feature sampling rate, or three times the sampling rate for full width at half the intensity of a feature, for example.

In various embodiments, the fixed window width is at least as large as an approximate baseline feature width. Wider flatter shapes (captured in right-singular vectors) are more consistently present across consecutive rows in the embedding, and this can lead to larger singular values, for example. Hence, with a fixed window width at least as large as the approximate baseline feature width, the strongest components represent the best flat wide approximation to the feature, which can end up cutting through some fraction of the height of the feature and leave the additional more narrow components to define feature shape. A fraction of the height of a feature can be 0.5 or the midpoint of the feature, for example. In various embodiments, a fraction of the height of a feature can be any fraction other than 0.5 or the midpoint of the feature.

Feature width, however, can vary across the mass spectrometry data. In various embodiments, this variation in feature width can be managed by splitting the data into sub-ranges. For example, a spectrum from a time-of-flight (TOF) mass spectrometer can be split into segments that each has a different mass-to-charge ratio (m/z). In various embodiments, this variation in feature width can also be managed by smoothing or interpolating the mass spectrometry data onto a different set of m/z values such that the feature sampling rate is uniform across the m/z range.

In various embodiments, the reconstruction step of SSA reconstructs data by summing the components of a grouped set. A variety of different sets can be used to reconstruct the data.

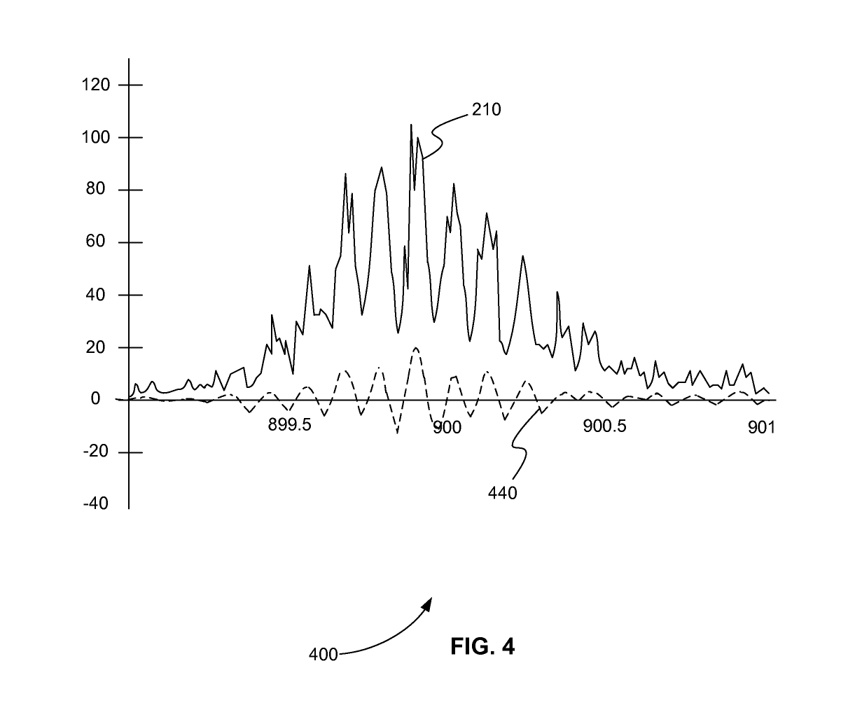

FIG. 4 is an exemplary plot 400 of mass spectrometry data 210 and reconstructed data 440 that is reconstructed from a grouped set that includes the second and third highest ranked linear components of mass spectrometry data 210 produced by SSA, in accordance with various embodiments. Reconstructed data 440 is a sum of the second highest ranked component, and the third highest ranked component.

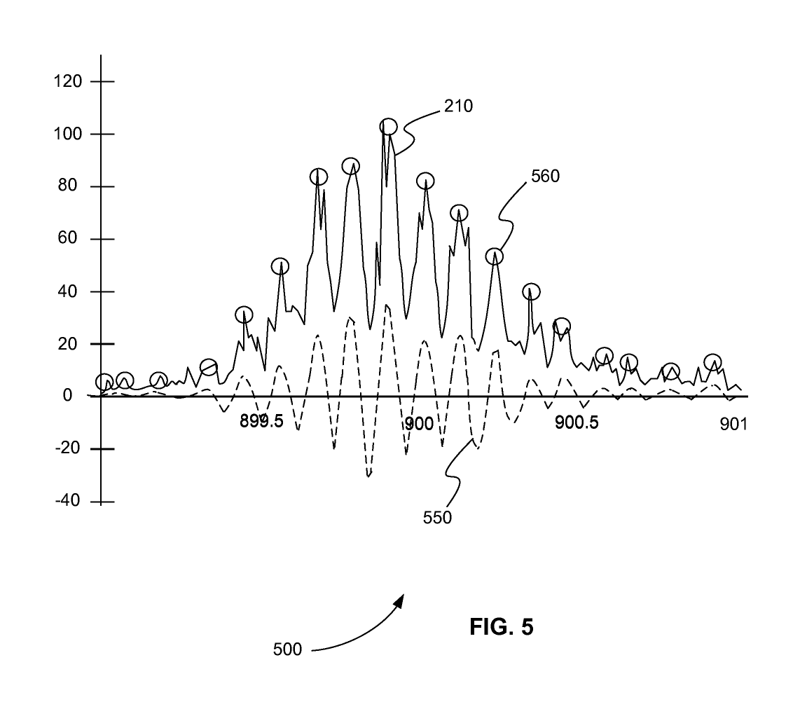

FIG. 5 is an exemplary plot 500 of mass spectrometry data 210 and reconstructed data 550 that is reconstructed from a grouped set that includes the second, third, fourth, and fifth highest ranked linear components of mass spectrometry data 210 produced by SSA, in accordance with various embodiments. Reconstructed data 550 is a sum of the second highest ranked component, the third highest ranked component, the fourth highest ranked component, and the fifth highest ranked component.

In various embodiments, reconstructed data 550 is used to identify bounds on a location of a feature in mass spectrometry data 210. Because the highest ranked component is excluded from reconstructed data 550, the reconstructed data includes locations where the values of the data change from positive to negative values and negative to positives values. These locations, or zero crossings, are used to identify features. For example, locations of reconstructed data 550 where the data transitions from negative to positive values correspond to the beginning of a feature and locations where the data transitions from positive to negative values correspond to the end of a feature.

Using these transition boundaries, features 560 in mass spectrometry data 210 are determined. For example, the centroid or apex of a feature can be calculated from the transition boundaries. Further, the centroid or apex of a feature can be used to assign a mass to a feature, and the calculation of the area of two or more features can be used to determine the quantity of a compound.

In various embodiments, these transition boundaries are used to determine a set of features to be modeled. Parameters of a feature model are then computed for each feature so as to best explain the original data. The mass assigned to the feature or the quantity of a compound can be determined from the feature model. Feature modeling can be used to identify blended features or peaks, for example.

In various embodiments, an apex or centroid of reconstructed data is used to identify a feature apex or centroid in mass spectrometry data 210. The bounds on a location of a feature can then be calculated from the feature apex or centroid, for example.

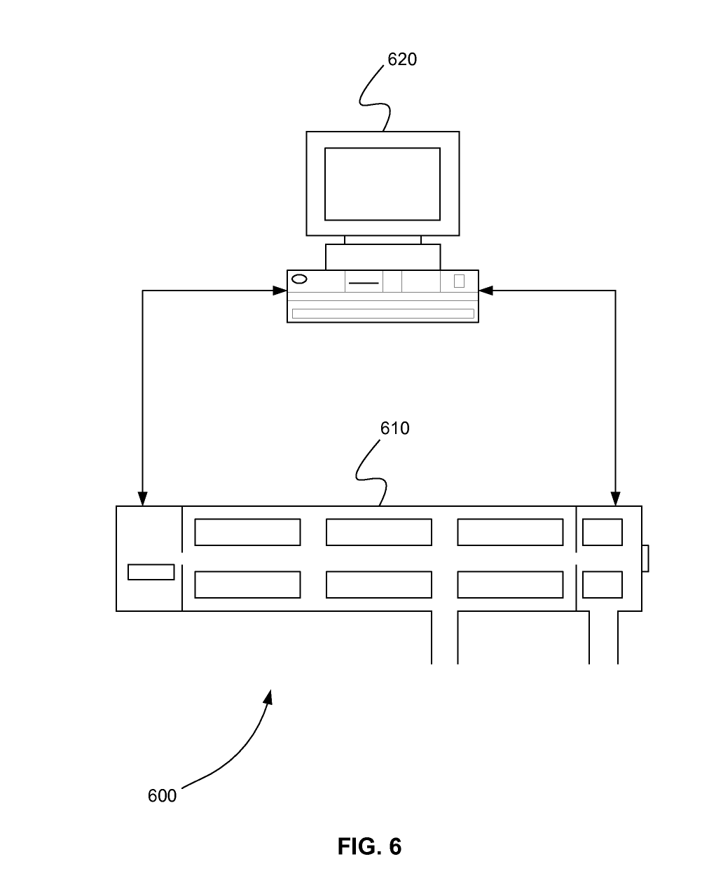

FIG. 6 is a schematic diagram showing a system 600 for detecting a feature from mass spectrometry data, in accordance with various embodiments. System 600 includes mass spectrometer 610, and processor 620. Mass spectrometer 610 can include, but is not limited to including, a time-of-flight (TOF), quadrupole, ion trap, Fourier transform, Orbitrap, or magnetic sector mass spectrometer. Mass spectrometer 610 can also include a separation device (not shown). The separation device can perform a separation technique that includes, but is not limited to, liquid chromatography, gas chromatography, capillary electrophoresis, or ion mobility.

Processor 620 is in communication with mass spectrometer 610. This communication can include data and control information. Processor 620 performs a number of steps.

Processor 620 obtains the mass spectrometry data from mass spectrometer 620. The mass spectrometry data can include, but is not limited to, LCMS data, image data, a mass spectrum, or a chromatogram. Processor 620 performs SSA on the mass spectrometry data using a fixed window width. In this SSA, one or more components other than the highest ranked component are grouped in a set and the one or more components grouped in the set are summed producing the reconstructed data.

In various embodiments, the number or count of the one or more components other than the highest ranked component that are grouped in the set is based on a sub-linear function. The sub-linear function can be, for example, the square root of the fixed window width. In various embodiments, the one or more components other than the highest ranked component that are grouped in the set are consecutive components or are non-consecutive components.

In various embodiments, the one or more components other than the highest ranked component that are grouped in the set are grouped based on a heuristic. For example, a heuristic can include grouping one or more components other than the highest ranked component based on a correlation among the one or more components.

Processor 620 detects a feature of the mass spectrometry data by analyzing an aspect of the reconstructed data. An aspect of the reconstructed data can include a maxima, a minima, a zero crossing, or any other intensity of the reconstructed data, or a maxima, a minima, a zero crossing, or any other intensity of a derivative of the reconstructed data.

In various embodiments, analyzing an aspect of the reconstructed data includes using locations of transitions from negative to positive values and from positive to negative values in the reconstructed data to detect bounds on a location of the feature in the mass spectrometry data. In various embodiments, analyzing an aspect of the reconstructed data comprises using a location of a maximum in the reconstructed data to a location in the mass spectrometry data to detect an apex of the feature in the mass spectrometry data.

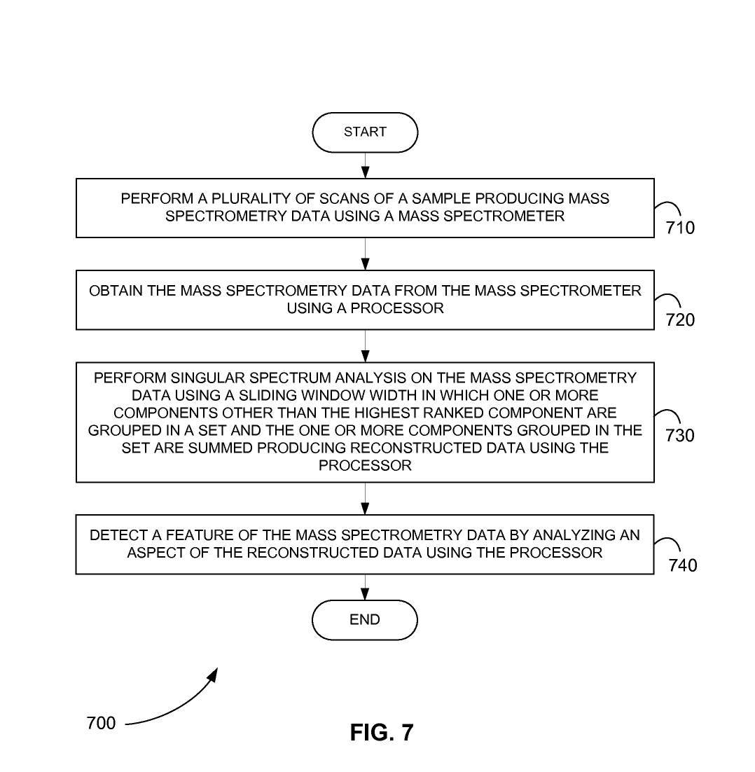

FIG. 7 is an exemplary flowchart showing a method 700 for detecting a feature from mass spectrometry data, in accordance with various embodiments.

In step 710 of method 700, a plurality of scans of a sample is performed producing mass spectrometry data using a spectrometer.

In step 720, the mass spectrometry data is obtained from the mass spectrometer using a processor.

In step 730, singular spectrum analysis is performed on the mass spectrometry data using a fixed window width in which one or more components other than the highest ranked component are grouped in a set and the one or more components grouped in the set are summed producing reconstructed data using the processor.

In step 740, a feature of the mass spectrometry data is detected by analyzing an aspect of the reconstructed data using the processor.

In various embodiments, a computer program product includes a tangible computer-readable storage medium whose contents include a program with instructions being executed on a processor so as to perform a method for detecting a feature from mass spectrometry data. This method is performed by a system of distinct software modules.

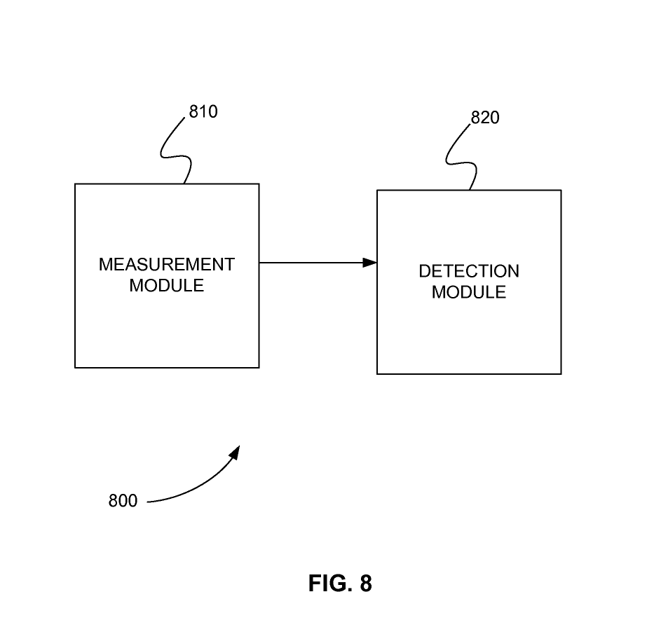

FIG. 8 is a schematic diagram of a system 800 of distinct software modules that performs a method for detecting a feature from mass spectrometry data, in accordance with various embodiments. System 800 includes measurement module 810 and detection module 820.

Measurement module 810 and detection module 820 perform a number of steps. Measurement module 810 obtains mass spectrometry data from a mass spectrometer that performs a plurality of scans of a sample.

Detection module 820 performs SSA on the mass spectrometry data using a fixed window width. In this SSA, one or more components other than the highest ranked component are grouped in a set, and the one or more components grouped in the set are summed producing reconstructed data. Detection module 820 then detects a feature of the mass spectrometry data by analyzing an aspect of the reconstructed data.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A system for detecting a feature from mass spectrometry data, comprising:
a mass spectrometer that performs a plurality of scans of a sample producing mass spectrometry data; and
a processor in communication with the mass spectrometer that
obtains the mass spectrometry data from the mass spectrometer,
performs singular spectrum analysis on the mass spectrometry data in which one or more components other than the highest ranked component are grouped in a set and the one or more components grouped in the set are summed producing reconstructed data, and
detects a feature of the mass spectrometry data by analyzing an aspect of the reconstructed data.

2. The system of claim 1, wherein the mass spectrometry data comprises a mass spectrum.

3. The system of claim 1, wherein the mass spectrometry data comprises a chromatogram.

4. The system of claim 1, wherein the number of the one or more components other than the highest ranked component that are grouped in the set is based on a sub-linear function.

5. The system of claim 4, wherein the processor performs singular spectrum analysis using a fixed window width and wherein the sub-linear function comprises a square root of the fixed window width.

6. The system of claim 1, wherein the one or more components other than the highest ranked component that are grouped in the set are consecutive components.

7. The system of claim 1, wherein the one or more components other than the highest ranked component that are grouped in the set are not consecutive components.

8. The system of claim 1, wherein the one or more components other than the highest ranked component that are grouped in the set are grouped based on a heuristic.

9. The system of claim 8, wherein the heuristic includes grouping one or more components other than the highest ranked component based on a correlation among the one or more components.

10. The system of claim 1, wherein analyzing an aspect of the reconstructed data comprises using locations of transitions from negative to positive values and from positive to negative values in the reconstructed data to detect bounds on a location of the feature in the mass spectrometry data.

11. The system of claim 1, wherein analyzing an aspect of the reconstructed data comprises using a location of a maximum in the reconstructed data to detect an apex of the feature in the mass spectrometry data.

12. A method for detecting a feature from mass spectrometry data, comprising:
performing a plurality of scans of a sample producing mass spectrometry data using a mass spectrometer;
obtaining the mass spectrometry data from the mass spectrometer using a processor;
performing singular spectrum analysis on the mass spectrometry data in which one or more components other than the highest ranked component are grouped in a set and the one or more components grouped in the set are summed producing reconstructed data using the processor; and
detecting a feature of the mass spectrometry data by analyzing an aspect of the reconstructed data using the processor.

13. The method of claim 12, wherein the mass spectrometry data comprises a mass spectrum.

14. The method of claim 12, wherein the mass spectrometry data comprises a chromatogram.

15. The method of claim 12, wherein the number of the one or more components other than the highest ranked component that are grouped in the set is based on a sub-linear function.

16. The method of claim 15, wherein performing singular spectrum analysis on the mass spectrometry data comprises using a fixed window width and wherein the sub-linear function comprises a square root of the fixed window width.

17. The method of claim 12, wherein the one or more components other than the highest ranked component that are grouped in the set are consecutive components.

18. The method of claim 12, wherein the one or more components other than the highest ranked component that are grouped in the set are not consecutive components.

19. The method of claim 12, wherein the one or more components other than the highest ranked component that are grouped in the set are grouped based on a heuristic.

20. The method of claim 19, wherein the heuristic includes grouping one or more components other than the highest ranked component based on a correlation among the one or more components.

21. The method of claim 12, wherein analyzing an aspect of the reconstructed data comprises using locations of transitions from negative to positive values and from positive to negative values in the reconstructed data to detect bounds on a location of the feature in the mass spectrometry data.

22. The method of claim 12, wherein analyzing an aspect of the reconstructed data comprises using a location of a maximum in the reconstructed to detect an apex of the feature in the mass spectrometry data.

23. A computer program product, comprising a tangible computer-readable storage medium whose contents include a program with instructions being executed on a processor so as to perform a method for detecting a feature from mass spectrometry data, the method comprising:
providing a system, wherein the system comprises distinct software modules, and wherein the distinct software modules comprise a measurement module and an detection module;
obtaining the mass spectrometry data from the mass spectrometer that performs a plurality of scans of a sample using the measurement module;
performing singular spectrum analysis on the mass spectrometry data in which one or more components other than the highest ranked component are grouped in a set and the one or more components grouped in the set are summed producing reconstructed data using the detection module; and
detecting a feature of the mass spectrometry data by analyzing an aspect of the reconstructed data using the detection module.
